(19) United States
(12) Patent Application Publication
(10) Pub. No.: US 2025/0304060 A1
(43) Pub. Date: Oct. 2, 2025

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventors: Ryota Kameda, Tokyo (JP); Sho Tamura, Tokyo (JP)

(21) Appl. No.: 19/059,599

(22) Filed: Feb. 21, 2025

(30) Foreign Application Priority Data
Mar. 26, 2024 (JP) 2024-050359

(51) Int. Cl. B60W 30/12

(52) U.S. Cl. CPC B60W 30/12; B60W 2420/403; B60W 2552/53; B60W 2556/40

(57) ABSTRACT

A mobile object control device of an embodiment includes a first recognizer that recognizes a first compartment line and objects in the vicinity of a mobile object based on a detection device, a second recognizer that recognizes a second compartment line from map, a determiner that determines a deviation between the first and the second compartment line, and a movement controller that controls movement of the mobile object based on at least one of the first compartment line and the second compartment line, in which movement of the mobile object is controlled in accordance with the objects when the first and the second compartment line exist on one side of right and left sides when viewed from the mobile object, the mobile object changes a course to the one side, and the first and the second compartment line on the one side deviate from each other during the course change.

### CROSS-REFERENCE TO RELATED APPLICATION

Priority is claimed on Japanese Patent Application No. 2024-050359, filed Mar. 26, 2024, the content of which is incorporated herein by reference.

### BACKGROUND

### Field of the Invention

The present invention relates to a mobile object control device, a mobile object control method, and a storage medium.

### Description of Related Art

In recent years, efforts to provide access to sustainable transportation systems that take into consideration vulnerable traffic participants among transportation participants have been gaining momentum. In order to achieve this, efforts have been concentrated on research and development of automated driving technology to further improve traffic safety and convenience. In relation to this, in the related art, technology for detecting road surface patterns formed by uneven parts of a road surface of a lane change destination and correcting a lane change path so as not to interfere with the road surface patterns when a vehicle would interfere with the road surface patterns on the lane change path is known (for example, Japanese Patent No. 6294928).

### SUMMARY

However, in automated driving technology of the related art, it cannot be said that sufficient consideration has been given to the control of movement of a mobile object when changing lanes in accordance with results of a comparison between road compartment lines recognized by a camera or the like and road compartment lines shown in map information, and there is room for further consideration thereof.

In order to solve the above problem, one of the objects of the present application is to provide a mobile object control device, a mobile object control method, and a storage medium which are capable of executing more appropriate movement control in accordance with the surrounding conditions of a mobile object when changing lanes. This also contributes to the development of a sustainable transportation system.

The mobile object control device, mobile object control method, and storage medium according to the present invention adopt the following configurations.

(1) A mobile object control device according to one aspect of the present invention includes a first recognizer that recognizes surrounding conditions including objects in the vicinity of a mobile object and a first compartment line comparting a moving path along which the mobile object moves, on the basis of an output of a detection device that detects the surrounding conditions of the mobile object, a second recognizer that recognizes a second compartment line comparting a moving path in the vicinity of the mobile object from map information, on the basis of position information of the mobile object, a determiner that determines a deviation between the first compartment line and the second compartment line, and a movement controller that controls movement of the mobile object on the basis of at least one of the first compartment line and the second compartment line, in which the movement controller controls movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

(2) In the above aspect (1), the movement controller controls the movement of the mobile object in accordance with a physical boundary existing on the one side when the surrounding conditions of the mobile object satisfy a first condition, and the first condition is that a deviation angle between the first and second compartment lines on the one side is equal to or greater than a threshold value, and that the first compartment line on the one side has deviated from the second compartment line in a direction opposite to a lane change direction of the mobile object.

(3) In the above aspect (2), the movement controller controls the movement of the mobile object in accordance with the physical boundary existing on the one side when, in addition to the first condition, the moving path is not a branching path or a merging path, the moving path is not a section where the number of lanes increases or decreases, a curvature of the moving path is less than a threshold value, and a speed of the mobile object is equal to or higher than a predetermined speed.

(4) In the above aspect (1), the movement controller performs movement control in accordance with at least one of a first preceding mobile object and a second preceding mobile object when the surrounding conditions of the mobile object satisfy a second condition, the first preceding mobile object existing in front of a moving path before the mobile object changes a course, and the second preceding mobile object existing in front of a moving path which is a course change destination of the mobile object, and the second condition is that a moving speed when the first and second compartment lines on the one side are adjusted from a state where their positions in a moving path width direction differ to a state where one of the first and second compartment lines overlaps with the other is equal to or higher than a predetermined speed, and that a deviation distance between the positions of the first and second compartment lines on the one side in the moving path width direction is equal to or greater than a threshold value.

(5) In the above aspect (4), the movement controller performs movement control in accordance with at least one of the first preceding mobile object and the second preceding mobile object when, in addition to the second condition, the moving path is not a branching path or a merging path, the moving path is not a section where the number of lanes increases or decreases, a curvature of the moving path is less than a threshold value, and a speed of the mobile object is equal to or higher than a predetermined speed.

(6) A mobile object control method according to another aspect of the present invention is a mobile object control method including causing a computer to recognize surrounding conditions including objects in the vicinity of a mobile object and a first compartment line comparting a moving path along which the mobile object moves, on the basis of an output of a detection device that detects the surrounding conditions of the mobile object, recognize a second compartment line comparting a moving path in the vicinity of the mobile object from map information, on the basis of position information of the mobile object, determine a deviation between the first compartment line and the second compartment line, control movement of the mobile object on the basis of at least one of the first compartment line and the second compartment line, and control movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

(7) A storage medium according to another aspect of the present invention is a computer-readable non-transitory storage medium storing a program causing a computer to recognize surrounding conditions including objects in the vicinity of a mobile object and a first compartment line comparting a moving path along which the mobile object moves, on the basis of an output of a detection device that detects the surrounding conditions of the mobile object, recognize a second compartment line comparting a moving path in the vicinity of the mobile object from map information, on the basis of position information of the mobile object, determine a deviation between the first compartment line and the second compartment line, control movement of the mobile object on the basis of at least one of the first compartment line and the second compartment line, and control movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

According to the above aspects (1) to (7), it is possible to execute more appropriate movement control in accordance with the surrounding conditions of a mobile object when changing lanes.

### BRIEF DESCRIPTION OF THE DRAWINGS

FIG. 1 is a configuration diagram of a vehicle system including a mobile object control device according to an embodiment.

FIG. 2 is a functional configuration diagram of a first controller and a second controller.

FIG. 3 is a diagram showing driving control of a host vehicle in a first scene.

FIG. 4 is a diagram showing driving control of a host vehicle in a second scene.

FIG. 5 is a diagram showing driving control of a host vehicle in a third scene.

FIG. 6 is a diagram showing driving control of a host vehicle in a fourth scene.

FIG. 7 is a flowchart showing an example of a flow of a driving control process in an embodiment.

FIG. 8 is a flowchart showing a first example of a traveling control process.

FIG. 9 is a flowchart showing a second example of a traveling control process.

### DESCRIPTION OF EMBODIMENTS

Hereinafter, an embodiment of a mobile object control device, a mobile object control method, and a storage medium of the present invention will be described with reference to the drawings. In the following description, a vehicle is used as an example of a mobile object, and an embodiment in which the mobile object control device is applied to an automated driving vehicle will be described. Automated driving is, for example, to execute driving control by automatically controlling one or both of steering and speed of a vehicle. Examples of the driving control described above may include, for example, various driving control such as an automated lane change (ALC), a lane keeping assistance system (LKAS), an adaptive cruise control system (ACC), a traffic jam pilot (TJP), and a collision mitigation brake system (CMBS). Driving control (so-called manual driving) of an automated driving vehicle may be executed by a manual operation of a user (for example, an occupant) of the vehicle. In addition to a vehicle, a mobile object may include, for example, a ship that can move on the ground such as a hovercraft, an aircraft that can run on a road, a stand-up vehicle having a power unit, and the like.

### Overall Configuration

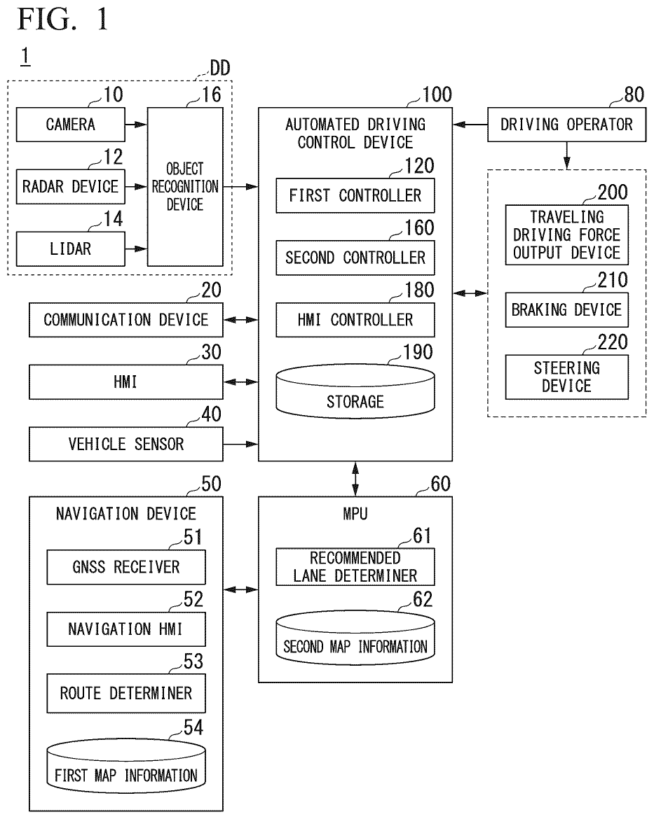

FIG. 1 is a configuration diagram of a vehicle system 1 including a mobile object control device according to an embodiment. A vehicle on which the vehicle system 1 is mounted (hereinafter referred to as a vehicle M) is, for example, a two-wheeled, three-wheeled, or four-wheeled vehicle or micromobility, and its driving source is an internal combustion engine such as a diesel engine or a gasoline engine, an electric motor, or a combination of these. The electric motor operates using power generated by a generator connected to the internal combustion engine, or discharged power from a battery (storage battery) such as a secondary battery or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a traveling driving force output device 200, a braking device 210, and a steering device 220. These devices and apparatuses are connected to each other by multiple communication lines such as a controller area network (CAN) communication line, a serial communication line, a wireless communication network, or the like. The configuration shown in FIG. 1 is merely an example, and a part of the configuration may be omitted, or other configurations may be added. The combination of the camera 10, the radar device 12, the LIDAR 14, and the object recognition device 16 is an example of a “detection device DD”. The HMI 30 is an example of an “output device”. The automated driving control device 100 is an example of a “mobile object control device”.

The camera 10 is a digital camera using a solid-state imaging element such as a charge coupled device (CCD) or a complementary metal oxide semiconductor (CMOS). The camera 10 is attached to any location on the host vehicle M on which the vehicle system 1 is mounted. When capturing an image of the front, the camera 10 is attached to an upper part of a front windshield, the back of a room mirror, a front head part of a vehicle body, or the like. When capturing an image of the rear, the camera 10 is attached to an upper part of a rear windshield, a back door, or the like. When capturing an image of the side, the camera 10 is attached to a door mirror, or the like. For example, the camera 10 periodically captures images of the surroundings of the host vehicle M. The camera 10 may be a stereo camera.

The radar device 12 emits radio waves such as millimeter waves around the host vehicle M and detects radio waves (reflected waves) reflected by the surrounding object to detect at least the position (distance and direction) of the object. The radar device 12 is attached to any location on the host vehicle M. The radar device 12 may detect the position and speed of an object by using a frequency modulated continuous wave (FM-CW) method.

The LIDAR 14 emits light around the host vehicle M and measures scattered light. The LIDAR 14 detects a distance to the object on the basis of a period of time between light emission and light reception. The emitted light is, for example, a pulsed laser beam. The LIDAR 14 is attached to any location on the host vehicle M.

The object recognition device 16 performs a sensor fusion process on detection results obtained from some or all of the camera 10, the radar device 12, and the LIDAR 14 to recognize the position, type, speed, and the like of the object. The object recognition device 16 outputs recognition results to the automated driving control device 100. The object recognition device 16 may output the detection results obtained from the camera 10, the radar device 12, and the LIDAR 14 to the automated driving control device 100 as they are. In this case, the object recognition device 16 may be omitted from the configuration of the vehicle system 1 (detection device DD).

The communication device 20 uses a network such as a cellular network, a Wi-Fi network, Bluetooth (registered trademark), dedicated short range communication (DSRC), a local area network (LAN), a wide area network (WAN), or the Internet to communicate with, for example, other vehicles in the vicinity of the host vehicle M, a terminal device of a user who uses the host vehicle M, or various server devices.

The HMI 30 outputs various information to the occupant of the host vehicle M and receives input operations by the occupant. The HMI 30 includes, for example, various display devices, a speaker, a buzzer, a touch panel, switches, keys, a microphone, and the like.

The vehicle sensor 40 includes a vehicle speed sensor that detects the speed of the host vehicle M, an acceleration sensor that detects an acceleration, a yaw rate sensor that detects a yaw rate (for example, a rotational angular velocity around the vertical axis passing through the center of gravity of the host vehicle M), and a direction sensor that detects the direction of the host vehicle M. The vehicle sensor 40 may be provided with a position sensor that detects the position of the host vehicle M. The position sensor is an example of a “position measurement unit”. The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50. The vehicle sensor 40 may derive the speed of the host vehicle M from a difference (that is, a distance) in position information at a predetermined time from the position sensor. A result detected by the vehicle sensor 40 is output to the automated driving control device 100.

The navigation device 50 includes, for example, the GNSS receiver 51, a navigation HMI 52, and a route determiner 53. The navigation device 50 stores first map information 54 in a storage device such as a hard disk drive (HDD) or a flash memory. The GNSS receiver 51 specifies the position of the host vehicle M on the basis of a signal received from a GNSS satellite. The position of the host vehicle M may be specified or complemented by an inertial navigation system (INS) that uses the output of the vehicle sensor 40. The navigation HMI 52 includes a display device, a speaker, a touch panel, keys, and the like. The GNSS receiver 51 may be provided in the vehicle sensor 40. The navigation HMI 52 may be partially or entirely shared with the HMI 30 mentioned above. For example, the route determiner 53 determines a route (hereinafter, a route on a map) from the position of the host vehicle M specified by the GNSS receiver 51 (or an input arbitrary position) to a destination input by the occupant using the navigation HMI 52 with reference to the first map information 54. The first map information 54 is, for example, information in which a road shape is expressed by links indicating roads (one example of a moving path) and nodes connected by the links. The first map information 54 may include point of interest (POI) information and the like. The route on the map is output to the MPU 60. The navigation device 50 may perform route guidance using the navigation HMI 52 on the basis of the route on the map. The navigation device 50 may transmit the current position and the destination to a navigation server via the communication device 20, and acquire a route equivalent to the route on the map from the navigation server. The navigation device 50 outputs the determined route on the map to the MPU 60.

The MPU 60 includes, for example, a recommended lane determiner 61, and stores second map information 62 in a storage device such as an HDD or a flash memory. The recommended lane determiner 61 divides the route on the map provided by the navigation device 50 into a plurality of blocks (for example, every 100 [m] in a vehicle traveling direction), and determines a recommended lane for each block with reference to the second map information 62. The recommended lane determiner 61 determines which lane from the left to travel in. When there is a branching point on the route on the map, the recommended lane determiner 61 determines the recommended lane so that the host vehicle M can travel along a reasonable route to proceed to the branching point.

The second map information 62 is map information with higher accuracy than the first map information 54. The second map information 62 includes, for example, the number of lanes (number of moving paths), the types and shapes of road compartment lines (hereinafter referred to as compartment lines), information on the centers of the lanes, information on road boundaries, and the like. The second map information 62 may include information on whether the road boundary is a boundary (physical boundary) including a structure that the vehicle cannot pass through (including crossing and contacting). The physical boundary may be, for example, a guardrail, a curb, a median strip, a fence, and the like. The fact that the vehicle cannot pass through the structure may include the fact that there is a low step that allows the vehicle to pass if vibrations of the vehicle that do not usually occur are tolerated. The second map information 62 may include road shape information, traffic regulation information, address information (address and zip code), facility information, parking lot information, telephone number information, and the like. The road shape information may be, for example, the curvature of a road (which may be rephrased as a radius of curvature. The same applies below), width, gradient, and the like. The second map information 62 may be updated (renewed) at any time by the communication device 20 communicating with an external device. The first map information 54 and the second map information 62 may be provided as an integrated piece of map information. The map information may be stored in the storage 190.

The driving operator 80 include, for example, a steering wheel, an accelerator pedal, and a brake pedal. The driving operator 80 may include a shift lever, a special steering wheel, a joystick, and other operators. Each operator of the driving operator 80 is equipped with an operation detector that detects, for example, the amount of operation of the operator by the occupant or whether an operation has occurred. The operation detector detects, for example, a steering angle and steering torque of the steering wheel, and the amount of depression of the accelerator pedal and the brake pedal. The operation detector outputs a detection result to the automated driving control device 100, or one or both of the driving force output device 200, the braking device 210, and the steering device 220.

The automated driving control device 100 executes various driving controls related to automated driving for the host vehicle M. The automated driving control device 100 includes, for example, a first controller 120, a second controller 160, an HMI controller 180, and a storage 190. The first controller 120, the second controller 160, and the HMI controller 180 are each implemented by a hardware processor such as a central processing unit (CPU) executing a program (software). Some or all of these components may be implemented by hardware (including circuitry) such as a large scale integration (LSI), an application specific integrated circuit (ASIC), a field-programmable gate array (FPGA), a graphics processing unit (GPU), or a system on chip (SOC), or may be implemented by software and hardware in cooperation. The above-described program may be stored in advance in a storage device (storage device including a non-transitory storage medium) such as an HDD or flash memory of the automated driving control device 100, or may be stored in a removable storage medium such as a DVD, CD-ROM, or memory card, and the storage medium (non-transitory storage medium) may be installed in the storage device of the automated driving control device 100 by being mounted on a drive device, a card slot, or the like.

The storage 190 may be implemented by the above-described various storage devices, or an electrically erasable programmable read only memory (EEPROM), a read only memory (ROM), a random access memory (RAM), or the like. The storage 190 stores, for example, various information, programs, and the like in the embodiment. The storage 190 may store map information (for example, the first map information 54 and the second map information 62).

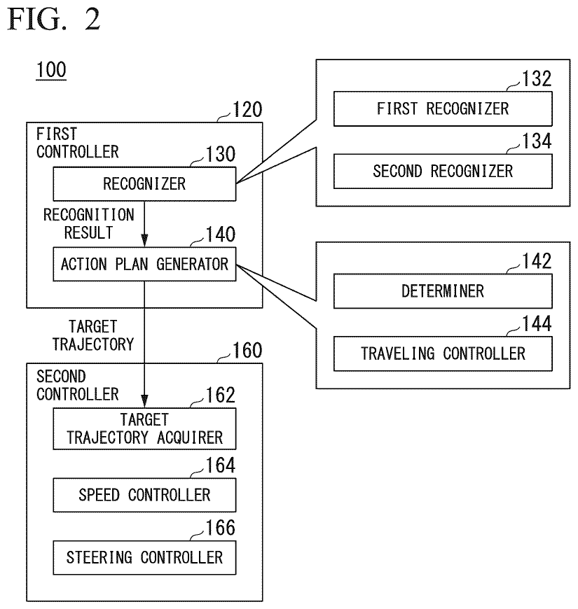

FIG. 2 is a functional configuration diagram of the first controller 120 and the second controller 160. The first controller 120 includes, for example, a recognizer 130 and an action plan generator 140. The first controller 120 implements, for example, a function by artificial intelligence (AI) and a function by a previously given model in parallel. For example, a function of “recognizing an intersection” may be implemented by performing recognition of an intersection by deep learning or the like and recognition based on a previously given condition (a signal that can be pattern-matched, a road marking, and the like) in parallel, and scoring and comprehensively evaluating both. This ensures the reliability of automated driving. The first controller 120 executes control related to the automated driving of the host vehicle M on the basis of instructions received from, for example, the MPU 60, the HMI controller 180, and the like.

The recognizer 130 recognizes the surrounding conditions of the host vehicle M on the basis of the recognition result of the detection device DD (information that is input from the camera 10, the radar device 12, and the LIDAR 14 via the object recognition device 16). For example, the recognizer 130 recognizes the state of an object in the vicinity (within a predetermined distance) of the host vehicle M, such as the position, speed, acceleration, and the like of the object. The object includes traffic participants such as other vehicles, pedestrians, and bicycles, and physical boundaries that compart a road (moving path). The position of the object is recognized as a position on an absolute coordinate system with a representative point (center of gravity, center of drive shaft, or the like) of the host vehicle M as the origin, and is used for control. The position of the object may be represented by a representative point such as the center of gravity or a corner of the object, or may be represented by a represented area. For example, when the object is a mobile object such as another vehicle, the “state” of the object may include the acceleration or jerk of a mobile object, or an “action state” (for example, whether the other vehicle is changing lanes or is attempting to change lanes).

The recognizer 130 recognizes, for example, stop lines, obstacles, red lights, toll booths, other road events, markings on roads (speed limits), and road signs indicating speed limits. The recognizer 130 includes, for example, a first recognizer 132 and a second recognizer 134. Details of these functions will be described later.

The action plan generator 140 generates an action plan for causing the host vehicle M to travel by automated driving on the basis of the recognition results of the recognizer 130. For example, the action plan generator 140 generates a target trajectory for the host vehicle M to travel in the recommended lane determined by the recommended lane determiner 61 in principle, and further travel automatically (without relying on a driver's operation) in the future so as to be able to cope with the surrounding conditions of the host vehicle M on the basis of the recognition results of the recognizer 130 and the surrounding road shapes based on the current position of the host vehicle M acquired from the map information. The target trajectory includes, for example, a speed element. For example, the target trajectory is expressed as a sequence of points (trajectory points) to be reached by the host vehicle M. The trajectory points are points that the host vehicle M should reach at every predetermined travel distance (for example, approximately several meters) along the road, and separately, a target speed and a target acceleration are generated for every predetermined sampling time (for example, approximately every several tenths of a [sec]) as a part of the target trajectory. The trajectory points may be positions that the host vehicle M should reach at every predetermined sampling time. In this case, the information on the target speed and target acceleration is expressed by intervals between the trajectory points.

The action plan generator 140 may set an event of automated driving when generating the target trajectory. The event may include, for example, a constant speed travel event in which the host vehicle M travels in the same lane at a constant speed, a following travel event in which the host vehicle M follows another vehicle that is present within a predetermined distance (for example, within 100 [m]) in front of the host vehicle M and is closest to the host vehicle M, a lane change event in which the host vehicle M changes lanes from the host vehicle's own lane to an adjacent lane, a branching event in which the host vehicle M branches into a lane on the destination side at a branching point of the road, a merging event in which the host vehicle M merges into a main lane at a merging point, a takeover event for ending automated driving and switching to manual driving, and the like. The event may include, for example, an overtaking event in which the host vehicle M changes lanes once to an adjacent lane, overtakes a preceding vehicle in the adjacent lane, and then changes lanes back to the original lane, an avoidance event in which the host vehicle M performs at least one of braking and steering to avoid an obstacle in front of the host vehicle M, and the like.

The action plan generator 140 may change an event already determined for the current section to another event or set a new event for the current section, depending on the surrounding conditions of the host vehicle M recognized while the host vehicle M is traveling, for example. The action plan generator 140 may change an event already set for the current section to another event or set a new event for the current section, depending on the operation of the occupant on the HMI 30. The action plan generator 140 generates a target trajectory depending on the set event.

The action plan generator 140 includes, for example, a determiner 142 and a traveling controller 144. Details of these functions will be described later. The traveling controller 144 and the second controller 160 are examples of a “movement controller”.

The second controller 160 controls the traveling driving force output device 200, the braking device 210, and the steering device 220 so that the host vehicle M passes through the target trajectory generated by the action plan generator 140 at the scheduled time.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores it in a memory (not shown). The speed controller 164 controls the traveling driving force output device 200 or the braking device 210 on the basis of a speed element associated with the target trajectory stored in the memory. The steering controller 166 controls the steering device 220 in accordance with the curvature of the target trajectory stored in the memory. Processes of the speed controller 164 and the steering controller 166 are implemented, for example, by a combination of feedforward control and feedback control. As an example, the steering controller 166 executes a combination of feedforward control according to the curvature of the road in front of the host vehicle M and feedback control based on a deviation from the target trajectory.

Referring back to FIG. 1, the HMI controller 180 notifies the occupant of predetermined information through the HMI 30. The predetermined information includes, for example, information related to the traveling of the host vehicle M, such as information on the state of the host vehicle M and information on driving control. The information on the state of the host vehicle M includes, for example, the speed of the host vehicle M, an engine speed, a shift position, and the like. The information on driving control includes, for example, information for inquiring whether driving control has been performed by automated driving and whether to start automated driving, information on the driving control status by automated driving, information on an automation level, information for prompting the occupant to drive when switching from automated driving to manual driving, and the like. The predetermined information may include information on the surrounding conditions recognized by the detection device DD. The predetermined information may include information not related to the traveling of the host vehicle M, such as television programs, content (for example, movies) stored in a storage medium such as a DVD. The predetermined information may include, for example, information on the current position and destination in automated driving, and the remaining amount of fuel of the host vehicle M. The HMI controller 180 may output the information received by the HMI 30 to the communication device 20, the navigation device 50, the first controller 120, and the like.

The HMI controller 180 may output, to the HMI 30, inquiry information for the occupant, processing results obtained by the first controller 120 and the second controller 160, and the like. The HMI controller 180 may transmit various information to be output by the HMI 30 to a terminal device used by the occupant of the host vehicle M via the communication device 20.

The traveling driving force output device 200 outputs a traveling driving force (torque) for the vehicle to travel to the driving wheels. The traveling driving force output device 200 includes, for example, a combination of an internal combustion engine, an electric motor, a transmission, and the like, and an electronic control unit (ECU) that controls these. The ECU controls the above-described components in accordance with information input from the second controller 160 or information input from the accelerator pedal of the driving operator 80.

The braking device 210 includes, for example, a brake caliper, a cylinder that transmits hydraulic pressure to the brake caliper, an electric motor that generates hydraulic pressure in the cylinder, and a brake ECU. The brake ECU controls the electric motor in accordance with information input from the second controller 160 or information input from the brake pedal of the driving operator 80, and a brake torque corresponding to a braking operation is output to each wheel. The braking device 210 may include a backup mechanism that transmits hydraulic pressure generated by the operation of the brake pedal to the cylinder via a master cylinder. The braking device 210 is not limited to the configuration described above, and may be an electronically controlled hydraulic brake device that controls an actuator in accordance with information input from the second controller 160 to transmit the hydraulic pressure in the master cylinder to the cylinder.

The steering device 220 includes, for example, a steering ECU and an electric motor. The electric motor changes the direction of steered wheels by applying a force to, for example, a rack and pinion mechanism. The steering ECU drives the electric motor in accordance with information input from the second controller 160 or information input from the steering wheel of the driving operator 80 to change the direction of the steered wheels.

### Recognizer and Action Plan Generator

Next, the functions of the recognizer 130 (mainly the first recognizer 132 and the second recognizer 134) and the action plan generator 140 (mainly the determiner 142 and the traveling controller 144) will be described in detail. Hereinafter, the contents of the driving control (traveling control) of the host vehicle M using the functions of the recognizer 130 and the action plan generator will be described in several scenes.

### First Scene

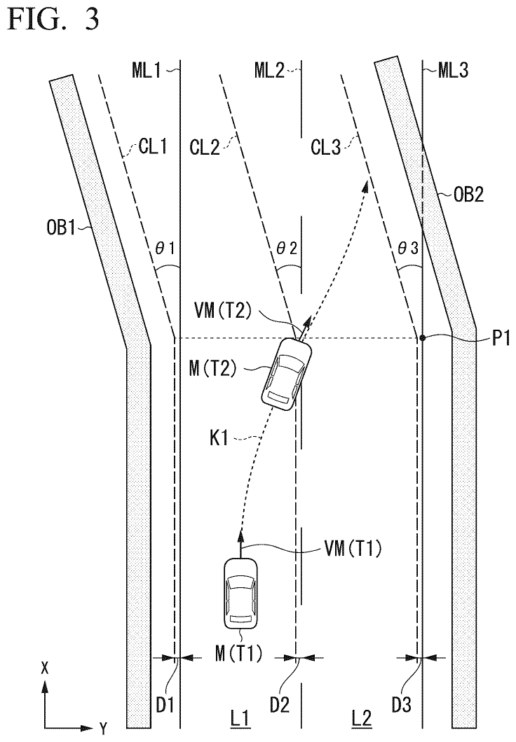

FIG. 3 is a diagram showing driving control of the host vehicle M in a first scene. In the example of FIG. 3, compartment lines CL1 to CL3 recognized by the detection device DD and compartment lines ML1 to ML3 obtained from map information (for example, the second map information 62) on the basis of the position information of the host vehicle M are shown. In the map information, a lane L1 is comparted by the compartment lines ML1 and ML2, and a lane L2 is comparted by the compartment lines ML2 and ML3. The lanes L1 and L2 are lanes on which the vehicle can travel in the same direction (the X-axis direction in the drawing). In the example of FIG. 3, the compartment lines CL1 to CL3 are an example of a “first compartment line”, and the compartment lines ML1 to ML3 are an example of a “second compartment line”. Hereinafter, the compartment lines CL1 to CL3 may be referred to as “camera compartment lines CL1 to CL3”, and the compartment lines ML1 to ML3 may be referred to as “map compartment lines ML1 to ML3”. Furthermore, when the camera compartment lines CL1 to CL3 are not distinguished from one another, they may be simply referred to as “camera compartment lines CL”, and when the map compartment lines ML1 to ML3 are not distinguished from one another, they may be simply referred to as “map compartment lines ML”.

In the example of FIG. 3, a physical boundary (for example, a fence) OB1 exists to the left of the lane L1 when viewed from the lane L1 in a travelable direction (X-axis direction in the drawing), and a physical boundary (for example, a fence) OB2 exists to the right of the lane L2 when viewed from the lane L2 in a travelable direction. In the example of FIG. 3, the physical boundaries OB1 and OB2 exist along the extension direction of the lanes L1 and L2 (more specifically, the physical boundary OB1 exists along the compartment line CL1, and the physical boundary OB2 exists along the compartment line CL3). The first scene shown in FIG. 3 shows a situation in which the host vehicle M traveling on the lane L1 at a speed VM changes lanes to the lane L2 by ALC. In the example of FIG. 3, it is assumed that time elapses in the order of time T1 and time T2. It is assumed that the host vehicle M(T*) and the speed VM(T*) indicate the position and speed of the host vehicle M at the time T*. The same applies to the description of the subsequent drawings.

The first scene shows a situation where, for example, the host vehicle M is in the middle of performing lane change (an example of course change) control by ALC in a construction zone or the like (before the lane change is completed), and particularly, the camera compartment line CL in front of the host vehicle M deviates from the map compartment line ML while at least a part of the host vehicle M is passing over (straddling) the compartment line. In this case, the camera compartment line CL corresponding to the compartment line temporarily drawn on a road surface to avoid a construction site is correct, and thus when a route is determined on the basis of an incorrect map compartment line ML, the host vehicle M may deviate from the lane or enter the construction site. For this reason, in the embodiment, driving control (movement control) according to the first scene is executed.

The first recognizer 132 recognizes the surrounding conditions of the host vehicle M on the basis of the output of the detection device DD that detects the surrounding conditions (external world) of the host vehicle M. For example, the first recognizer 132 recognizes the left and right camera compartment lines CL1 and CL2 that compart a traveling lane (lane L1) of the host vehicle M on the basis of an image captured by the camera 10 (hereinafter, a camera image). The first recognizer 132 may recognize the camera compartment line CL3 that comparts an adjacent lane (lane L2) adjacent to the traveling lane.

For example, the first recognizer 132 analyzes the camera image, extracts edge points in the image which have a large difference in brightness from adjacent pixels, and recognizes the camera compartment lines CL1 to CL3 in the image plane by connecting the edge points. The first recognizer 132 converts the positions of the camera compartment lines CL1 to CL3 based on the position of a representative point of the host vehicle M into those of a vehicle coordinate system (for example, the XY plane coordinates in FIG. 3).

The first recognizer 132 may recognize, for example, the curvatures of the camera compartment lines CL1 to CL3. The camera compartment lines CL1 to CL3 may be recognized or corrected on the basis of the output of a detection device (for example, the radar device 12, the LIDAR 14) other than the camera 10. The first recognizer 132 may recognize curvature change amounts of the camera compartment lines CL1 to CL3. The curvature change amounts are, for example, rates of change over time of the curvatures of the camera compartment lines CL1 to CL3 recognized by the camera 10 at a distance x [m] forward as viewed from the host vehicle M. The first recognizer 132 may average the curvatures or curvature change amounts of the camera compartment lines CL1 to CL3 to recognize the curvatures or curvature change amounts of lanes comparted by the camera compartment lines CL1 to CL3. The camera compartment lines CL1 to CL3 may be recognized or corrected on the basis of the output of a detection device (for example, the radar device 12, the LIDAR 14) other than the camera 10.

In the first scene, the first recognizer 132 recognizes physical boundaries OB1 and OB2 that exist in the vicinity of the host vehicle M. In the first scene, when another vehicle exists in the vicinity of the host vehicle M, the first recognizer 132 may recognize the other vehicle.

The second recognizer 134 recognizes lane compartment lines in the vicinity of the host vehicle M from map information on the basis of the position of the host vehicle M detected by, for example, the vehicle sensor 40 or the GNSS receiver 51. For example, the second recognizer 134 recognizes the map compartment lines ML1 to ML3 that exist in the traveling direction of the host vehicle M or in the direction in which the host vehicle M can travel, with reference to map information on the basis of the position information of the host vehicle M.

The second recognizer 134 may recognize the map compartment lines ML1, ML2 as compartment lines comparting the traveling lane of the host vehicle M, and may recognize the map compartment lines ML2, ML3 as compartment lines comparting adjacent lanes, among the recognized map compartment lines ML1 to ML3. The second recognizer 134 recognizes the curvatures or curvature change amounts of the map compartment lines ML1 to ML3 from the second map information 62. The second recognizer 134 may average the curvatures or curvature change amounts of the map compartment lines ML1 to ML3 to recognize the curvatures or curvature change amounts of the lanes comparted by the map compartment lines.

The determiner 142 determines whether the camera compartment lines CL1 to CL3 recognized by the first recognizer 132 deviate from the map compartment lines ML1 to ML3 recognized by the second recognizer 134. For example, the determiner 142 derives the degree of deviation between the compartment lines CL1 and ML1 located closest to the left side of the host vehicle M, the degree of deviation between the compartment lines CL2 and ML2 positioned closest to the right side of the host vehicle M, and the degree of deviation between the compartment lines CL3 and ML3 on the adjacent lane side. When the derived degree of deviation is equal to or greater than a threshold value, the determiner 142 determines that the camera compartment lines and the map compartment lines deviate from each other, and when the degree of deviation is less than the threshold value, the determiner 142 determines that they do not deviate from each other. The determination regarding whether they deviate from each other may be repeatedly performed at a predetermined timing or at predetermined cycles.

For example, the determiner 142 superimposes the camera compartment lines CL1, CL2, and CL3 and also superimposes the map compartment lines ML1, ML2, and ML3 on the plane (XY plane) of the vehicle coordinate system on the basis of the position of the representative point of the host vehicle M. When determining compartment lines to be compared with each other (the compartment lines CL1 and ML1, the compartment lines CL2 and ML2, and the compartment lines CL3 and ML3), the determiner 142 determines that the compartment lines deviate from each other when the degree of deviation of at least one compartment line is equal to or greater than a threshold value, and determines that the compartment lines do not deviate from each other when the degrees of deviation of all of the compartment lines are less than the threshold value. The degree of deviation is, for example, the degree of a shift amount (deviation distance, moving path width direction deviation) in the road width direction (moving path width direction, lateral direction, Y-axis direction in the drawing). In the example of FIG. 3, deviation determination may be performed using an average value of a shift amount D1 between the lateral positions of the compartment lines CL1 and ML1, a shift amount D2 between the lateral positions of the compartment lines CL2 and ML2, and a shift amount D3 between the lateral positions of the compartment lines CL3 and ML3, or deviation determination may be performed using the maximum or minimum values of the shift amounts D1, D2, and D3.

The degree of deviation may be, for example, the degree of an angle (deviation angle) between two compartment lines to be compared with each other, instead of (or in addition to) the above-described shift amount between the lateral positions. In the example of FIG. 3, an average value of an angle θ1 between the compartment lines CL1 and ML1, an angle θ2 between the compartment lines CL2 and ML2, and an angle θ3 between the compartment lines CL3 and ML3 may be used, or the maximum or minimum value of the angles θ1, θ2, and θ3 may be used.

The degree of deviation may be the degree (magnitude) of a difference in the curvature change amount between the compartment lines instead of (or in addition to) the above-described shift amounts of the lateral positions or the angle formed by the compartment lines. The curvature change amount is mainly used when a lane is a curved road. For example, the determiner 142 may use an average value of a difference in the curvature change amount between the compartment lines CL1 and ML1, a difference in the curvature change amount between the compartment lines CL2 and ML2, and a difference in the curvature change amount between the compartment lines CL3 and ML3, or may use the maximum or minimum value of the differences. The determiner 142 may use a difference between the average value of the curvature change amounts of the compartment lines CL1 to CL3 and the average value of the curvature change amounts of the compartment lines ML1 to ML3. A difference between a curvature change amount of a lane (lanes L1, L2) recognized from a camera image and a curvature change amount of a lane recognized from the map information may be used.

For example, when determining whether the camera compartment lines and the map compartment lines deviate from each other, the determiner 142 may determine whether the camera compartment lines are erroneously recognized on the basis of one or both of the curvature change amounts of the camera compartment lines detected by the recognizer 130 and the angles between the camera compartment lines and the map compartment lines. In this case, the determiner 142 performs erroneous recognition determination for the camera compartment lines when, for example, the direction of change in the curvature change amount and the direction of change in the angle are the same and the curvature change amount and the angle increase in accordance with a distance from the host vehicle M. Thereby, an increase in both the curvature change amount and the angle is determined to be erroneous recognition, and thus erroneous recognition of the camera compartment lines when traveling through a lane change section such as a curved road can be determined with higher accuracy.

The traveling controller 144 determines driving control for the host vehicle M on the basis of recognition results of the first recognizer 132 and the second recognizer 134 and a determination result of the determiner 142, and generates a target trajectory based on the determined driving control. “Determining driving control” may include, for example, determining the content (type) of driving control and determining whether to execute (curb) driving control. “Executing driving control” may include, for example, continuing driving control that is already being executed, in addition to switching and executing the content of driving control. Curbing driving control may include not only not executing driving control, but also lowering the automation level of driving control.

Here, the driving control executed by the traveling controller 144 includes at least first driving control and second driving control. The first driving control is, for example, driving control for executing at least steering control of the steering or speed of the host vehicle M on the basis of at least one of the camera compartment line CL and the map compartment line ML. For example, in the case of ALC control, the first driving control generates a traveling trajectory for the host vehicle M to change lanes from a traveling lane (for example, the lane L1) to a lane (for example, the lane L2) which is a lane change destination (course change destination), and causes the host vehicle M to travel so that a representative point of the host vehicle M travels on a trajectory along the generated traveling trajectory. In the case of LKAS control, the first driving control causes the host vehicle M to travel so that a representative point of the host vehicle M passes through the center of a lane comparted by compartment lines. In the first driving control, for example, when the camera recognition accuracy is less than a threshold value, driving control may be performed by giving priority to the map compartment line ML, and when the map information is old (for example, the map update date is earlier than a predetermined date and time), driving control may be performed by giving priority to the camera compartment line CL.

The second driving control is, for example, driving control for executing at least steering control of the steering or speed of the host vehicle M on the basis of an object (for example, a physical boundary, another vehicle) recognized by the first recognizer 132. The second driving control, for example, specifies the position of a lane on the basis of a physical boundary or the position of another vehicle, and causes the host vehicle M to travel so that a representative point of the host vehicle M travels in the center of the specified lane. The second driving control causes the host vehicle M to travel so that a representative point of the host vehicle M travels on a trajectory along the traveling trajectory of the other vehicle.

The driving control may include a plurality of driving controls having different automation levels (an example of the degree of automation). The automation levels include, for example, a first level, a second level having a lower degree of automation of the driving control than the first level, and a third level having a lower degree of automation of the driving control than the second level. The automation levels may include a fourth level having a lower degree of automation of the driving control than the third level. Here, the automation level may be a level determined by standardized information, laws, or the like, or may be an index value that is set independently of these. Thus, the types, contents, and number of automation levels are not limited to the following examples. For example, a low degree of automation of the driving control means that an automation rate in the driving control is low and a task imposed on a driver is large (severe). For example, a low degree of automation of the driving control means that the degree of control of the steering or acceleration/deceleration of the host vehicle M by the automated driving control device 100 is low (the degree of necessity of intervention in the steering or acceleration/deceleration operation by the driver is high). The task imposed on the driver is, for example, monitoring the surroundings of the host vehicle M and operating the driving operator. The operation of the driving operator includes, for example, a state where the driver is holding the steering wheel (hereinafter, referred to as a hands-on state). The task imposed on the driver is, for example, a task (driver task) for an occupant which is required to maintain the automated driving of the host vehicle M. Thus, when the occupant cannot execute the imposed task, the automation level will be lowered. For example, the first level of driving control may include, for example, driving control such as ALC, LKAS, ACC, TJP, and CMBS. The second level or the third level of driving control may include, for example, driving control such as ALC, LKAS, ACC, and CMBS. The fourth level of driving control may include manual driving. The fourth level of driving control may include, for example, driving control such as ACC and CMBS. Among the first to fourth levels, the first level has the highest degree of automation of driving control, and the fourth level has the lowest degree of automation of driving control.

At the first level, there is no task imposed on the occupant (a task imposed on the driver is the lightest), and thus, for example, driving control is permitted in a state where the driver of the host vehicle M is not holding the steering wheel (hereinafter, referred to as a hands-off state). At the second level, a task imposed on the driver is, for example, monitoring the surroundings (particularly the front) of the host vehicle M. At the third level, a task imposed on the driver is, for example, a hands-on state in addition to monitoring the surroundings of the host vehicle M. At the fourth level, a task imposed on the driver is, for example, an operation for controlling the steering and speed of the host vehicle M by the driving operator 80 in addition to monitoring the surroundings of the host vehicle M and being in a hands-on state. In other words, the case of the fourth level is a state where the occupant is ready to take over driving immediately, and a task imposed on the driver is the heaviest. The contents of the driving control at each automation level and the tasks imposed on the occupant are not limited to the above-described examples. The automated driving control device 100 executes driving control at any one of the first to fourth levels on the basis of the surrounding conditions of the host vehicle M and the tasks being performed by the occupant.

For example, the traveling controller 144 executes first driving control when the determiner 142 determines that the camera compartment lines and the map compartment lines do not deviate from each other, and executes second driving control when the determiner 142 determines that the camera compartment lines and the map compartment lines deviate from each other. For example, when a predetermined condition is satisfied, the traveling controller 144 may perform control of switching from the first driving control to the second driving control, or may perform control such as ending the driving control of the host vehicle M and switching to manual driving by the occupant. The traveling controller 144 may switch the automation level in accordance with the surrounding conditions and the type of driving control.

In the first scene shown in FIG. 3, the automated driving control device 100 executes a lane change from the lane L1 to the lane L2 by the ALC control according to the first driving control at the timing of time T1. In this case, the driver is in a hands-off state. For example, at time T1, the determiner 142 determines whether the camera compartment line CL3 and the map compartment line ML3 deviate from each other, the camera compartment line CL3 being at least a compartment line in the direction in which the host vehicle M changes lanes (in other words, a compartment line that is farther away when viewed from the host vehicle M before the lane change) among the compartment lines that compart the lane L2 to which the host vehicle M is to change lanes. The determiner 142 may determine whether the compartment lines (the camera compartment line CL2 and the map compartment line ML2) on the other side of the lane L2 to which the host vehicle M is to change lanes deviate from each other or whether the camera compartment line CL1 and the map compartment line ML1 deviate from each other, and may determine whether the camera compartment line CL and the map compartment line ML deviate from each other as a whole.

Here, at time T1, the vicinity of the host vehicle M (within a predetermined distance from the host vehicle M) does not include a point P1 shown in FIG. 3 where the camera compartment line CL and the map compartment line ML deviate from each other. Thus, the determiner 142 determines that at least the camera compartment line CL3 and the map compartment line ML3 do not deviate from each other. The traveling controller 144 executes ALC by the first driving control on the basis of the above-described determination result, generates a target trajectory K1 for changing lanes from the lane L1 to the lane L2 on the basis of at least one of the camera compartment line CL3 and the map compartment line ML3, and controls the steering and speed of the host vehicle M so that the host vehicle M travels along the generated target trajectory K1.

The determiner 142 continues to perform the deviation determination between the camera compartment line CL3 and the map compartment line ML3 even during the lane change. In this case, the lateral movement of the host vehicle M due to the lane change (movement in the road width direction (Y-axis direction in the drawing)) also causes a shift in the lateral positions of the camera compartment line CL3 and the map compartment line ML3. Even in this case, on the basis of the determination result indicating that the camera compartment line CL3 and the map compartment line ML3 coincide with each other at time T1, when the deviation distance is not equal to or greater than a predetermined distance, a matching process for moving the position of one of the camera compartment line CL3 and the map compartment line ML3 (for example, the camera compartment line CL3) so that the position overlaps the position of the other (for example, the map compartment line ML3) is performed, and the lateral movement control of the host vehicle M is performed while adjusting the position of the compartment line viewed from the host vehicle M as needed. When matching is performed, driving control is in progress, and thus the greater the distance between the camera compartment line CL and the map compartment line ML is, the higher the speed of movement to the compartment line to which the host vehicle M is to move (the greater the amount of lateral movement in a predetermined time) is set so that matching can be completed rapidly (within a predetermined time).

In the first scene, at time T2 when the host vehicle is changing lanes, the determiner 142 determines that at least the camera compartment line CL3 and the map compartment line ML3 deviate from each other (more specifically, determines that they deviate from each other on the basis of a deviation angle). In this case, the traveling controller 144 performs traveling control of the host vehicle M in accordance with an object (an object other than a compartment line) which is present in the vicinity. The phrase “in accordance with an object” may mean “in accordance with the type or position of an object”, or may mean “in accordance with the presence or absence of an object”.

For example, when a first condition is satisfied at time T2, the traveling controller 144 performs traveling control of the host vehicle M by the second driving control in accordance with the physical boundary OB2 on the right side when viewed from the host vehicle M. The first condition is, for example, that the degree of deviation between the camera compartment line CL3 and the map compartment line ML3 is equal to or greater than a threshold value, and that the camera compartment line CL3 deviates from the map compartment line ML3 in a direction (leftward in the case of FIG. 3) opposite to the lane change direction (course change direction, rightward in the case of FIG. 3) of the host vehicle M. In the example of FIG. 3, in order to satisfy the above-described first condition, the host vehicle M is caused to travel along a target trajectory that is generated to travel along the physical boundary OB2 at a position a predetermined distance away from the physical boundary OB2 on the basis of the position of the physical boundary OB2. Thereby, even when the camera compartment line CL3 deviates from the map compartment line ML3, driving control in a hands-off state can be continued using the physical boundary OB2. The traveling controller 144 may use the physical boundary OB1 in addition to (or instead of) the physical boundary OB2. The traveling controller 144 ends the ALC control when the host vehicle M is positioned at a predetermined position of the lane L2 (for example, the center of the lane).

In this manner, according to the first scene, for example, in a situation in which a lane change destination is temporarily under construction and the number of lanes does not change but the lanes are temporarily detouring to avoid a construction site, a detouring compartment line actually drawn on the road surface is recognized as the camera compartment line CL, and thus deviates from the map compartment line ML. For this reason, when lane change control is continued using the map compartment line in a case where a lane change is performed near the start position of such a deviation, there is a possibility that the vehicle will approach the construction site. Consequently, in the embodiment, when there is such deviation of a compartment line, the host vehicle M is caused to travel in a traveling lane estimated in accordance with a physical boundary (assuming a structure for separation from the construction site), and thus it is possible to continue driving control while preventing the movement of the vehicle from becoming unstable during driving control.

In addition to the first condition, the traveling controller 144 may include a condition that the road on which the host vehicle M is traveling (a road within a predetermined distance in the traveling direction when viewed from the host vehicle M) is not a branch road or a merging road, is not a section in which the number of lanes included in the road increases or decreases, the curvature of the road is less than a threshold value, and the speed of the host vehicle M is equal to or higher than a predetermined speed. In this manner, in addition to the first condition, by limiting the situation to a situation in which there is no increase or decrease in lanes, there is no erroneous detection due to the influence of a curved road, and the speed is suitable for changing lanes, and by allowing the continuation of ALC control at a point where a compartment line that is a temporary detour due to construction or the like starts in a state where the number of lanes remains the same, excessive continuation of traveling control can be curbed.

At time T2 in the first scene, when the surrounding conditions of the host vehicle M do not satisfy the first condition, the HMI controller 180 may output an alarm or the like to the HMI 30 to give a notification to an occupant, and the traveling controller 144 may stop the ALC control being executed and switch to control such as manual driving. The traveling controller 144 may determine whether to immediately end or continue the lane change control in accordance with the state of the lane change of the host vehicle M at time T2. For example, when the position of the host vehicle M is beyond the camera compartment line CL2 (or the map compartment line ML2) (at least a part of the vehicle body is passing over the compartment line), the ALC control is continued until the lane change is completed, and otherwise, control such as switching to manual driving is performed. When the traveling controller 144 continues the driving control until the lane change is completed, control such as lowering the automation level may be performed.

### Second Scene

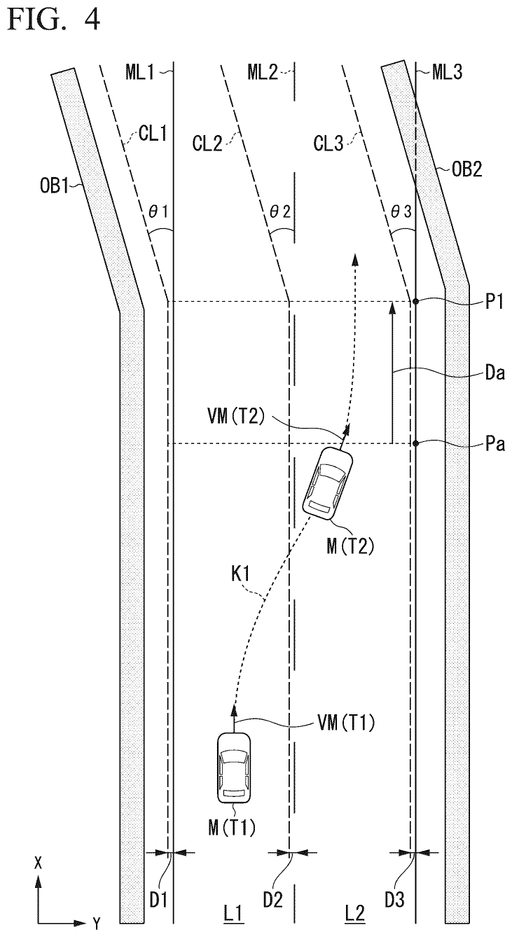

FIG. 4 is a diagram showing the driving control of the host vehicle M in the second scene. In the second scene, a position (or timing) at which the camera compartment line CL and the map compartment line ML deviate from each other during a lane change is different from that in the first scene described above. Specifically, the drawing shows a situation in which the camera compartment line CL and the map compartment line ML deviate from each other at a point P1 in front of a point Pa at which the entire body of the host vehicle M has passed over the camera compartment line CL2 (or the map compartment line ML2) (in other words, the entire body of the host vehicle M is on the lane L2). In the second scene, instead of the entire body of the host vehicle M having passed over the camera compartment line CL2, another criterion such as the representative point of the host vehicle M having passed over the camera compartment line CL2 may be used. In the following, description will be mainly given focusing on parts where control different from that in the first scene is performed, and description of parts where the same control is performed (for example, the control at time T1, and the like) will be omitted.

At time T2 in the second scene, the determiner 142 determines that at least the camera compartment line CL3 and the map compartment line ML3 deviate from each other at the point P1 that is a distance Da ahead of the point Pa where the host vehicle M passes over the camera compartment line CL2 (or the map compartment line ML2). In this case, the traveling controller 144 determines whether the distance Da from the point Pa to the point P1 is within a first predetermined distance, and when it is within the first predetermined distance, the traveling controller 144 continues the ALC control of the host vehicle M through the first driving control in accordance with an object present in the vicinity, as in the first scene. The object in the second scene is the physical boundary OB2 on the right side of the lane L2 when viewed from the host vehicle M as in the first scene, but the physical boundary OB1 may be used in addition to (or instead of) the physical boundary OB2.

In addition to the first condition, the traveling controller 144 may include a condition that the road on which the host vehicle M is traveling is not a branch road or a merging road, is not a section in which the number of lanes included in the road increases or decreases, the curvature of the road is less than a threshold value, and the speed of the host vehicle M is equal to or higher than a predetermined speed. According to the second scene, the same effect as in the first scene can be achieved. Thus, according to the second scene, more appropriate movement control can be executed in accordance with the surrounding conditions after the lane change.

In this manner, in the first and second scenes, when the camera compartment line CL and the map compartment line ML deviate from each other while the host vehicle M is moving laterally in the road width direction (moving path width direction) due to ALC control, the vehicle has not been traveling continuously in the lane L2 after the lane change, and thus there is no traveling history of the lane L2 until immediately before, and the reliability becomes lower than that of the lane L1 in which the vehicle had been traveling. Consequently, in the embodiment, in such a situation, the lane to which the host vehicle M will change lanes is estimated using the physical boundaries of the road, and thus it is possible to continue the traveling control while preventing the movement of the host vehicle M from becoming unstable during a lane change.

### Third Scene

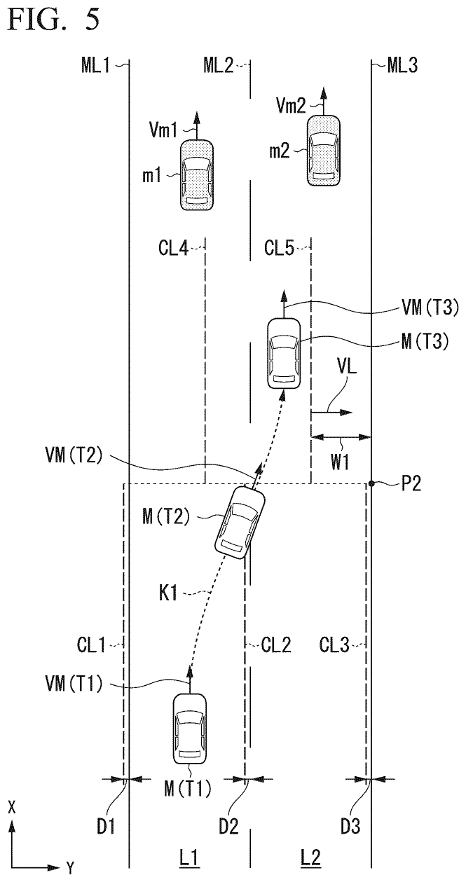

FIG. 5 is a diagram showing driving control of the host vehicle M in a third scene. The third scene shows a scene in which ALC control is performed in a case where, for example, a compartment line temporarily drawn on a road due to road repair work is forgotten to be removed or left unremoved after the road is repaired, and the temporarily drawn compartment line is painted with another color, but is recognized as a compartment line in a camera image due to a difference in color from the surrounding road surface, and the like.

For example, the third scene differs from the second scene in that, in addition to the camera compartment lines CL1 to CL3, there are camera compartment lines CL4 and CL5 in the traveling direction of the host vehicle M which should have been removed after the repair (or recognized in the camera image even when they have been removed). Unlike the second scene, in the lane L1, another vehicle m1 is traveling in front of the host vehicle M at a speed Vm1, and in the lane L2, another vehicle m2 is traveling in front of the host vehicle M at a speed Vm2. The other vehicle m1 is an example of a “first preceding mobile object”, and the other vehicle m2 is an example of a “second preceding mobile object”. In the example of FIG. 5, in addition to times T1 and T2, there is time T3, and it is assumed that time elapses in the order of times T1, T2, and T3. The other vehicles m1 and m2 move over time like the host vehicle M, but the description will be omitted here for convenience of explanation. In the following, the third scene will be described mainly focusing on differences from the second scene, and description of parts where the same control is performed will be omitted.

At time T1 in the third scene, it is assumed that the determiner 142 determines whether the camera compartment lines CL in the vicinity of the host vehicle M deviate from the map compartment lines ML as in the first and second scenes, and determines that they do not deviate from each other. In this case, the traveling controller 144 allows ALC control in a hands-off state, generates a target trajectory K1 for changing lanes from the lane L1 to the lane L2, and controls at least one of the steering and speed of the host vehicle M so that the host vehicle M travels along the generated target trajectory K1.

Time T2 is the time when the host vehicle M passes through a point P2 where the camera compartment line CL and the map compartment line ML deviate from each other while changing lanes, and is the time when a part of the host vehicle M passes over the camera compartment line CL2 (or the map compartment line ML2). At time T2, the camera compartment line CL5 and the map compartment line ML3 are shifted. In this situation, the host vehicle M is moving laterally in association with the lane change, and thus the determiner 142 performs a matching process for moving the position of one of the camera compartment line CL and the map compartment line ML (for example, the camera compartment line CL) so that the position overlaps the position of the other (for example, the map compartment line ML), and performs lateral movement control while adjusting the position of the compartment line viewed from the host vehicle M as needed.

When the traveling controller 144 continues the lane change on the basis of the camera compartment line CL5 after time T2 shown in FIG. 5, there is a possibility that the lane change will be completed at time T3 in a state where the host vehicle M is not in the center of the lane L2 but is to the left of the center (or a state where the entire body of the host vehicle M is not on the lane L2), and the host vehicle M will travel at a position offset from the map compartment line ML3. For this reason, when the surrounding conditions of the host vehicle M satisfy a second condition different from the above-described first condition, the traveling controller 144 executes traveling control through the second driving control according to an object in the vicinity of the host vehicle M. In the third scene, the object is, for example, at least one of another vehicle m1 in front of the lane L1 before the host vehicle M changes lanes and another vehicle m2 in front of the lane L2 to which the host vehicle M will change lanes. The second condition is, for example, that a moving speed VL of the compartment line is equal to or higher than a predetermined speed when adjusting the positions of the camera compartment line CL5 and the map compartment line ML3 on at least one side (for example, the right side) of the lane L2, which is a lane change destination, in the lane width direction (moving path width direction, Y-axis direction in the drawing, lateral direction) so that the positions are changed from a different position state to an overlapping position state, and that a deviation distance (moving path width direction deviation) W1 between the camera compartment line CL5 and the map compartment line ML3 in the lane width direction (moving path width direction) is equal to or greater than a threshold value.

When the second condition is satisfied, the traveling controller 144 estimates that the other vehicles m1 and m2 are traveling in the center of the lane on the basis of the position information (lateral position relative to the lane) of at least one of the other vehicles m1 and m2, and controls the lateral position of the host vehicle M when changing lanes. For example, when the host vehicle M travels on the basis of the other vehicle m2, the traveling controller 144 controls at least the steering of the host vehicle M so that the representative point of the host vehicle M travels along the traveling trajectory of the representative point of the other vehicle m2. When the host vehicle M travels on the basis of the other vehicle m1, the traveling controller 144 estimates the center position of the lane L2 based on the position of the other vehicle m1 on the basis of the position of the other vehicle m1 and the road widths (lateral widths) of the lanes L1 and L2 obtained from map information or a camera image, and controls at least the steering of the host vehicle M so that the representative point of the host vehicle M is positioned at the estimated center position.

In the third scene, as shown at time T3 in FIG. 5, due to the compartment line not being removed, the old compartment line is recognized, and the host vehicle travels at a position offset from the map compartment line ML, which leads to a concern that the position of the host vehicle at the lane change destination may become unstable. However, as described above, when the surrounding conditions of the host vehicle M satisfy the second condition, the vehicle can continue the ALC driving control in accordance with the surrounding conditions by generating a traveling position (target trajectory K1) on the basis of the other vehicles m1 and m2 in front and changing lanes. Thereby, for example, when the system determines that a lane change is to be performed to overtake a vehicle traveling ahead, the host vehicle can perform traveling control so as not to interfere with the overtaken vehicle or the preceding vehicle of the lane change destination, and the host vehicle can safely continue traveling control.

In the third scene, in addition to the second condition, the traveling controller 144 may include, as in the first condition, a condition that the road on which the host vehicle M is traveling (a road within a predetermined distance in the traveling direction when viewed from the host vehicle M) is not a branch road or a merging road, is not a section in which the number of lanes included in the road increases or decreases, the curvature of the road is less than a threshold value, and the speed of the host vehicle M is equal to or higher than a predetermined speed. In this manner, in addition to the second condition, by limiting the situation to a situation in which there is no increase or decrease in lanes, there is no erroneous detection due to the influence of a curved road, and the speed is suitable for changing lanes, and by allowing the continuation of ALC control at a point where the old compartment line remains in a state where the number of lanes remains the same, excessive continuation of traveling control can be curbed.

In the third scene, when the surrounding conditions of the host vehicle M do not satisfy the second condition, the HMI controller 180 may output an alarm or the like to the HMI 30 to give a notification to an occupant, and the traveling controller 144 may stop the ALC control being executed and switch to control such as manual driving. The traveling controller 144 may determine whether to immediately end or continue the lane change control in accordance with the state of the lane change of the host vehicle M at time T2. For example, when the position of the host vehicle M is beyond the camera compartment line CL2 (or the map compartment line ML2) (at least a part of the vehicle body is passing over the compartment line), the ALC control is continued until the lane change is completed, and otherwise, control such as switching to manual driving is performed. When the traveling controller 144 continues the driving control until the lane change is completed, control such as lowering the automation level may be performed.

### Fourth Scene

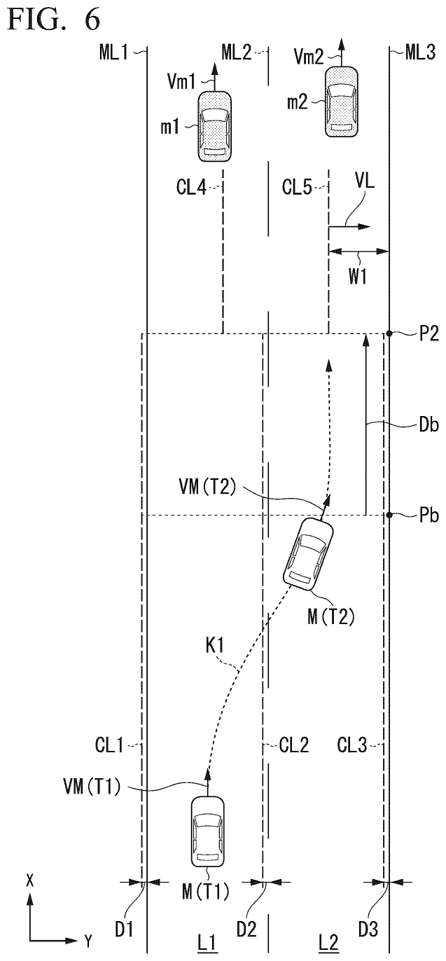

FIG. 6 is a diagram showing driving control of the host vehicle M in a fourth scene. In the fourth scene, a position (or timing) at which the camera compartment line CL and the map compartment line ML deviate from each other during a lane change is different from that in the third scene. Specifically, the drawing shows a situation in which the camera compartment lines CL4 and CL5 are recognized at a point P2 in front of a point Pb at which the entire body of the host vehicle M has passed over the camera compartment line CL2 (or the map compartment line ML2) (in other words, the entire body of the host vehicle M is on the lane L2), and deviate from the map compartment line ML. In the fourth scene, instead of the entire body of the host vehicle M having passed over the camera compartment line CL2, another criterion such as the representative point of the host vehicle M having passed over the camera compartment line CL2 may be used. In the following, description will be mainly given focusing on parts where control different from that in the third scene is performed, and description of parts where the same control is performed will be omitted.

In the fourth scene, the first recognizer 132 recognizes the camera compartment lines CL4 and CL5 at the point P2 in front of the current point Pb at time T2. The determiner 142 determines that at least the camera compartment line CL5 and the map compartment line ML3 deviate from each other at the point P2. In this case, the traveling controller 144 determines whether a distance Db from the point Pb to the point P2 is within a second predetermined distance, and when the distance Db is within the second predetermined distance, the traveling controller 144 performs traveling control of the host vehicle M in accordance with an object present in the vicinity, as in the third scene. The object in the fourth scene is, for example, at least one of the other vehicles m1 and m2, as in the third scene.

In addition to the second condition, the traveling controller 144 may include a condition that the road on which the host vehicle M is traveling is not a branch road or a merging road, is not a section in which the number of lanes included in the road increases or decreases, the curvature of the road is less than a threshold value, and the speed of the host vehicle M is equal to or higher than a predetermined speed. In this manner, according to the fourth scene, the same effect as in the third scene can be achieved. Thus, according to the fourth scene, more appropriate movement control can be executed in accordance with the surrounding conditions after the lane change.

In the matching process of the compartment lines in the third and fourth scenes, instead of moving the camera compartment lines CL to the map compartment lines ML, the map compartment lines ML may be moved to the camera compartment lines CL, and in this case, control is performed on the basis of the moving speed of the map compartment lines ML. The second predetermined distance in the third and fourth scenes may be longer than the first predetermined distance described above. The camera compartment lines CL4 and CL5 in the third and fourth scenes are compartment lines remaining after repairs, and are less risky than in the first and second scenes in which there is a possibility of entering a construction area. Furthermore, in the case of a section in which the camera compartment lines CL4 and CL5 are redrawn, they are assumed to exist over a long section, and thus, even when they are determined to be over a long distance, there is no significant effect on the traveling control.

In the third and fourth scenes of the embodiment, the lateral position of the host vehicle M when changing lanes may be controlled on the basis of position information (lateral position with respect to the lane) of at least one of another vehicle (first rear mobile object) existing behind in the lane L1 and another vehicle (first rear mobile object) existing behind in the lane L2 instead of (or in addition to) at least one of another vehicle m1 (first preceding mobile object) existing in front in the lane L1 before the host vehicle M changes lanes and another vehicle m2 (second preceding mobile object) existing in front in the lane L2 to which the host vehicle M is to change lanes. The first preceding mobile object and the second preceding mobile object in the embodiment were originally preceding mobile objects, but may be used as preceding mobile objects even when the host vehicle M has overtaken them and become a rear mobile object.

### Processing Flow

Processing executed by the automated driving control device 100 of the embodiment will be described below. The processing executed by the automated driving control device 100 will be described below, focusing mainly on a driving control process based on the recognition status of compartment lines, and the like. At the start of a flow, the host vehicle M is assumed to be executing predetermined driving control (for example, LKAS control in a first driving state (for example, the driver is in a hands-off state)). The processing shown below may be repeatedly executed at a predetermined timing or at predetermined cycles (for example, while the driving control is being executed by the automated driving control device 100).

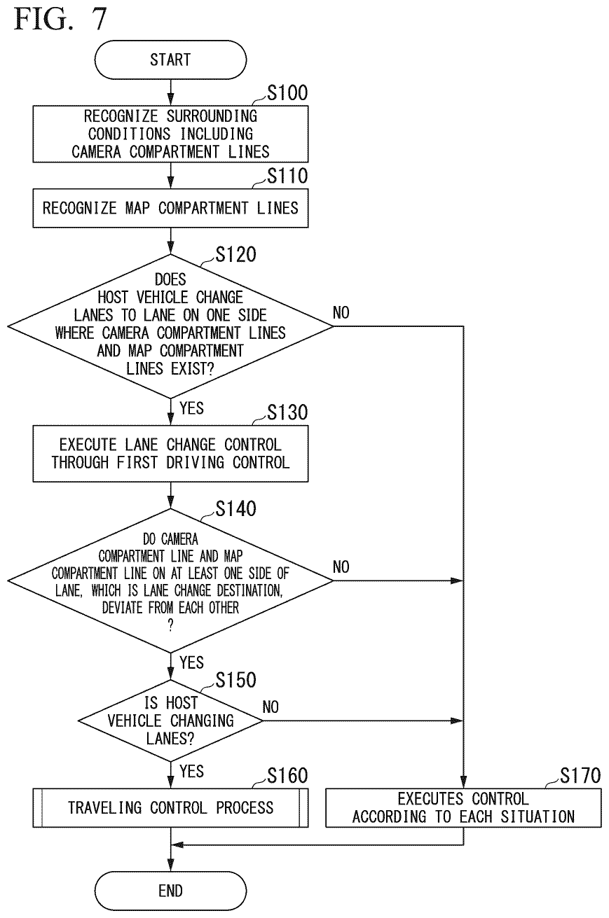

FIG. 7 is a flowchart showing an example of a flow of the driving control process in the embodiment. In the example of FIG. 7, the first recognizer 132 recognizes the surrounding conditions including the compartment lines (camera compartment lines) in the vicinity of the host vehicle M on the basis of an output of the detection device DD that detects the surrounding conditions of the host vehicle M (step S100). In the process of step S100, for example, objects (for example, physical boundaries, other vehicles, and the like) existing in the vicinity of the host vehicle M may be recognized. Next, the second recognizer 134 recognizes the compartment lines (map compartment lines) existing in the vicinity of the host vehicle M from map information with reference to the map information on the basis of position information of the host vehicle M (step S110).

Next, the traveling controller 144 determines whether to change lanes to a lane on one side (for example, the right side) where the camera compartment lines CL and the map compartment lines ML exist (are recognized) when viewed from the traveling lane of the host vehicle M (step S120). When it is determined that a lane change is to be performed, the traveling controller 144 executes lane change control (ALC control) in the first driving state (step S130). Next, the determiner 142 determines whether the camera compartment line CL and the map compartment line ML on at least one side (for example, the right side) of the lane, which is a lane change destination, deviate from each other (step S140). When it is determined that they deviate from each other, the traveling controller 144 determines whether the host vehicle M is changing lanes (step S150). When it is determined that the host vehicle M is changing lanes, the traveling controller 144 executes the traveling control process according to the surrounding conditions of the host vehicle M (step S160). The specific processing of the traveling control process in step S160 will be described later.

When it is determined in step S120 that the host vehicle will not change lanes to one side where the camera compartment line CL and the map compartment line ML exist, when it is determined in step S140 that the camera compartment line and the map compartment line on at least one side of the lane, which is a lane change destination, do not deviate from each other, or when it is determined in step S150 that the host vehicle is not changing lanes, the traveling controller 144 executes control according to each situation (step S170). In the process of step S170, for example, when it is determined in the process of step S120 that the host vehicle does not change lanes, the traveling controller 144 continues the current control (for example, LKAS control). When it is determined in the process of step S140 that the camera compartment line and the map compartment line do not deviate from each other, the traveling controller 144 executes control such as continuing the first driving state until the lane change is completed. In the process of step S150, when the host vehicle is not changing lanes (for example, a situation in which the host vehicle M is not passing through a compartment line that comparts a traveling lane from an adjacent lane), the traveling controller 144 performs control such as stopping the ALC control and switching to LKAS control for the lane before the lane change. In other situations, control according to each situation is also executed.

### Traveling Control Process: First Example

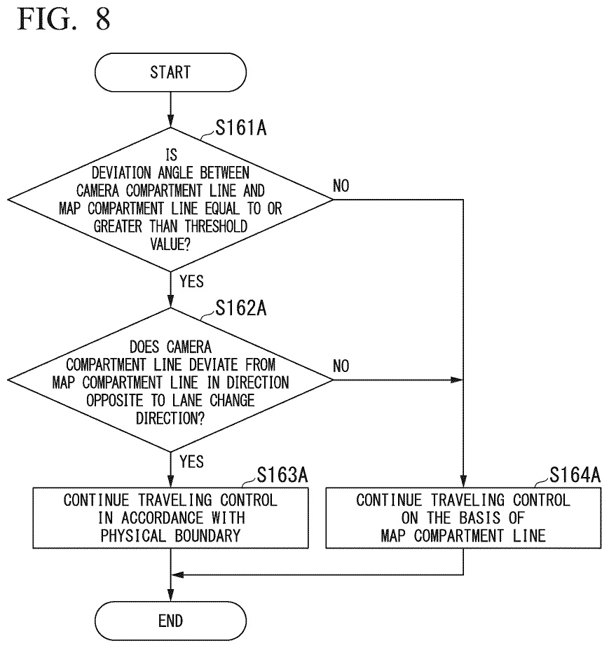

Next, a specific example of the process of step S160 will be described. FIG. 8 is a flowchart showing a first example of a traveling control process. FIG. 8 shows an example of a traveling control process in the first and second scenes described above. In the example of FIG. 8, the traveling controller 144 determines whether a deviation angle between the camera compartment line CL and the map compartment line ML determined by the determiner 142 is equal to or greater than a threshold value (step S161A).

When it is determined that the deviation angle is equal to or greater than the threshold value, the determiner 142 determines whether the camera compartment line CL deviates from the map compartment line ML in a direction (for example, leftward relative to the traveling direction in the lane) opposite to the lane change direction in which the host vehicle M changes lanes (for example, rightward relative to the traveling direction in the lane) (step S162A). When it is determined that they deviate from each other in the opposite direction, the traveling control (ALC control) by the second driving control is continued on the basis of the physical boundary existing in the vicinity of the host vehicle M (step S163A). In the process of step S161A, when the deviation between the camera compartment line CL and the map compartment line ML is not equal to or greater than the threshold value, or in the process of step S162A, when it is determined that the camera compartment line CL does not deviate from the map compartment line ML in the direction opposite to the lane change direction, for example, traveling control is executed on the basis of the map compartment line ML (step S164A). Thereby, the processing of this flowchart ends.

When the physical boundary is not recognized in the process of step S163A, the traveling controller 144 may perform control such as lowering an automation level or ending the driving control and switching to manual driving. In the process of step S164A, control of continuing the traveling control on the basis of the camera compartment line CL may be performed.

### Traveling Control Process: Second Example

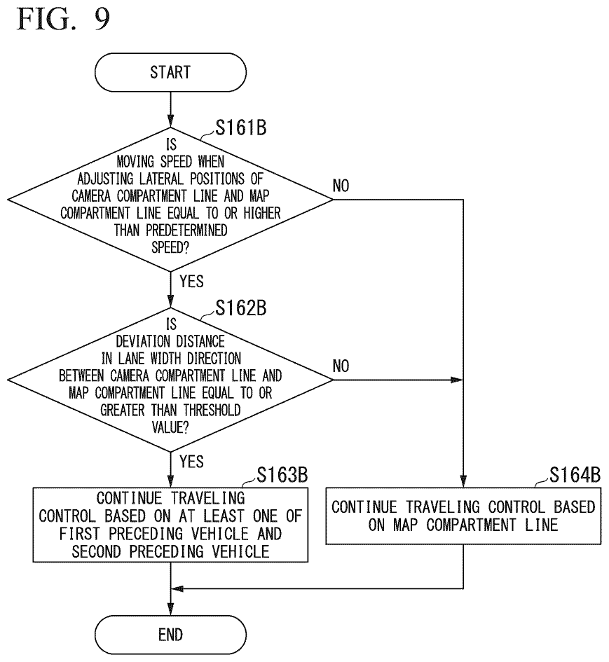

FIG. 9 is a flowchart showing a second example of a traveling control process. FIG. 9 shows an example of a traveling control process in the third and fourth scenes described above. In the example of FIG. 9, the traveling controller 144 determines whether the moving speed of one of the compartment lines is equal to or higher than a predetermined speed when adjusting the lateral positions of the camera compartment line CL and the map compartment line ML (step S161B). When it is determined that the moving speed of the compartment line is equal to or higher than the predetermined speed, the traveling controller 144 determines whether a deviation distance in the road width direction (lateral direction, lane width direction) between the camera compartment line CL and the map compartment line ML determined by the determiner 142 is equal to or greater than a threshold value (step S162B). When it is determined that the deviation distance is equal to or greater than the threshold value, the traveling controller 144 continues the traveling control (ALC control) according to the second driving control on the basis of at least one of a first preceding vehicle (an example of the first preceding mobile object) traveling ahead of the host vehicle M in the lane before the lane change and a second preceding vehicle (an example of the second preceding mobile object) traveling ahead of the host vehicle M in the lane to which the host vehicle is to change lanes (step S163B). When it is determined in the process of step S161B that the moving speed when adjusting the positions of the camera compartment line CL and the map compartment line ML is not equal to or higher than the predetermined speed, or when it is determined in the process of step S162B that the deviation distance in the lane width direction between the camera compartment line CL and the map compartment line ML is not equal to or greater than the threshold value, the traveling controller 144 continues the traveling control on the basis of, for example, the map compartment line ML (step S164B).

When neither the first preceding mobile object nor the second preceding mobile object is recognized in the process of step S163B, the traveling controller 144 may perform control of lowering the automation level or ending driving control and switching to manual driving. In the process of step S164B, the traveling control may be continued on the basis of the camera compartment line CL.

### Modification Example

In the above-described embodiment, ALC control in a hands-off state has been mainly described, but the same control may be performed for ALC control in a hands-on state. In the embodiment, in addition to the ALC control according to the determination of the system, the same control may be performed when ALC control is executed in response to a lane change instruction from an occupant of the host vehicle M (for example, an instruction from the HMI 30). Control when performing a lane change in the embodiment may be applied to a case where the vehicle changes lanes and then returns to the original lane through overtaking control, for example. In the embodiment, instead of determining whether the camera compartment line CL and the map compartment line ML deviate from each other, it may be determined whether the camera compartment line CL and the map compartment line ML coincide with each other. In addition to the above-described traveling control, control of at least one of the steering and speed of the host vehicle M may be executed to avoid contact with an object recognized by the recognizer 130.

According to the above-described embodiment, the automated driving control device 100 (an example of a mobile object control device) includes the first recognizer 132 that recognizes the surrounding conditions including objects in the vicinity of the host vehicle M and camera compartment lines (first compartment lines) for comparting the lane (an example of a moving path) in which the host vehicle M moves, on the basis of an output of the detection device DD that detects the surrounding conditions of the host vehicle M (an example of a mobile object), the second recognizer 134 that recognizes map compartment lines (second compartment lines) for comparting lanes in the vicinity of the host vehicle M from map information, on the basis of the position information of the host vehicle M, the determiner 142 that determines a deviation between the camera compartment line and the map compartment line, and the traveling controller 144 (an example of a movement controller) that controls the movement of the host vehicle M on the basis of at least one of the camera compartment line and the map compartment line. When a camera compartment line and a map compartment line exist on one side of the right and left sides of the host vehicle M, the host vehicle M changes a course (changes lanes) to one side, and the camera compartment line and the map compartment line on one side deviate from each other while the host vehicle M is changing a course, the traveling controller 144 can perform movement control of the host vehicle M in accordance with an object, thereby making it possible to execute more appropriate movement control in accordance with the surrounding conditions of the mobile object at the time of the lane change. This can contribute to the development of a sustainable transportation system.

For example, in the related art, when the camera compartment line CL and the map compartment line ML deviate from each other during a lane change, traveling control is canceled or a warning is issued because a host vehicle is moving laterally due to the lane change or has just moved laterally. However, according to the embodiment, when a camera compartment line and a map compartment line of the lane after the lane change deviate from each other in a case where a traveling distance during a lane change or after moving to an adjacent lane is within a predetermined distance, a traveling lane is estimated from surrounding objects (physical boundaries and surrounding vehicles), and thus when driving control for a lane change is being performed, traveling control can be continued while preventing the movement of the host vehicle M from becoming unstable.

The above-described embodiment can be expressed as follows.

A mobile object control device including:
a storage medium storing computer-readable instructions; and
a processor connected to the storage medium,
wherein the processor executes the computer-readable instructions to
recognize surrounding conditions including objects in the vicinity of a mobile object and a first compartment line comparting a moving path along which the mobile object moves, on the basis of an output of a detection device that detects the surrounding conditions of the mobile object,
recognize a second compartment line comparting a moving path in the vicinity of the mobile object from map information, on the basis of position information of the mobile object,
determine a deviation between the first compartment line and the second compartment line,
control movement of the mobile object on the basis of at least one of the first compartment line and the second compartment line, and
perform movement control of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

What is claimed is:

1. A mobile object control device comprising:
a first recognizer that recognizes surrounding conditions including objects in the vicinity of a mobile object and a first compartment line comparting a moving path along which the mobile object moves, on the basis of an output of a detection device that detects the surrounding conditions of the mobile object;
a second recognizer that recognizes a second compartment line comparting a moving path in the vicinity of the mobile object from map information, on the basis of position information of the mobile object;
a determiner that determines a deviation between the first compartment line and the second compartment line; and
a movement controller that controls movement of the mobile object on the basis of at least one of the first compartment line and the second compartment line,
wherein the movement controller controls movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

2. The mobile object control device according to claim 1, wherein
the movement controller controls the movement of the mobile object in accordance with a physical boundary existing on the one side when the surrounding conditions of the mobile object satisfy a first condition, and
the first condition is that a deviation angle between the first and second compartment lines on the one side is equal to or greater than a threshold value, and that the first compartment line on the one side has deviated from the second compartment line in a direction opposite to a lane change direction of the mobile object.

3. The mobile object control device according to claim 2, wherein the movement controller controls the movement of the mobile object in accordance with the physical boundary existing on the one side when, in addition to the first condition, the moving path is not a branching path or a merging path, the moving path is not a section where the number of lanes increases or decreases, a curvature of the moving path is less than a threshold value, and a speed of the mobile object is equal to or higher than a predetermined speed.

4. The mobile object control device according to claim 1, wherein
the movement controller performs movement control in accordance with at least one of a first preceding mobile object and a second preceding mobile object when the surrounding conditions of the mobile object satisfy a second condition, the first preceding mobile object existing in front of a moving path before the mobile object changes a course, and the second preceding mobile object existing in front of a moving path which is a course change destination of the mobile object, and
the second condition is that a moving speed when the first and second compartment lines on the one side are adjusted from a state where their positions in a moving path width direction differ to a state where one of the first and second compartment lines overlaps with the other is equal to or higher than a predetermined speed, and that a deviation distance between the positions of the first and second compartment lines on the one side in the moving path width direction is equal to or greater than a threshold value.

5. The mobile object control device according to claim 4, wherein the movement controller performs movement control in accordance with at least one of the first preceding mobile object and the second preceding mobile object when, in addition to the second condition, the moving path is not a branching path or a merging path, the moving path is not a section where the number of lanes increases or decreases, a curvature of the moving path is less than a threshold value, and a speed of the mobile object is equal to or higher than a predetermined speed.

6. A mobile object control method comprising:
causing a computer to:
recognize surrounding conditions including objects in the vicinity of a mobile object and a first compartment line comparting a moving path along which the mobile object moves, on the basis of an output of a detection device that detects the surrounding conditions of the mobile object;
recognize a second compartment line comparting a moving path in the vicinity of the mobile object from map information, on the basis of position information of the mobile object;
determine a deviation between the first compartment line and the second compartment line;
control movement of the mobile object on the basis of at least one of the first compartment line and the second compartment line; and
control movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.

7. A computer-readable non-transitory storage medium storing a program causing a computer to:
recognize surrounding conditions including objects in the vicinity of a mobile object and a first compartment line comparting a moving path along which the mobile object moves, on the basis of an output of a detection device that detects the surrounding conditions of the mobile object;
recognize a second compartment line comparting a moving path in the vicinity of the mobile object from map information, on the basis of position information of the mobile object;
determine a deviation between the first compartment line and the second compartment line;
control movement of the mobile object on the basis of at least one of the first compartment line and the second compartment line; and
control movement of the mobile object in accordance with the objects when the first compartment line and the second compartment line exist on one side of right and left sides when viewed from the mobile object, the mobile object changes a course to the one side, and the first compartment line and the second compartment line on the one side deviate from each other during the course change.
